(19) United States
(12) Patent Application Publication
(10) Pub. No.: US 2023/0184621 A1
(43) Pub. Date: Jun. 15, 2023

(54) EVENT DETECTION APPARATUS, METHOD AND PROGRAM

(71) Applicant: NEC Corporation, Minato-ku, Tokyo (JP)

(72) Inventors: Murtuza PETLADWALA, Tokyo (JP); Shohei KINOSHITA, Tokyo (JP); Shigeru KASAI, Tokyo (JP); Reishi KONDO, Tokyo (JP)

(73) Assignee: NEC Corporation, Minato-ku, Tokyo (JP)

(21) Appl. No.: 17/802,636

(22) PCT Filed: Mar. 12, 2020
(86) PCT No.: PCT/JP2020/010720

§ 371 Date: Aug. 26, 2022

(51) Int. Cl. G01M 5/00; G08G 1/01; G08G 1/015; G08G 1/065; G06F 17/14

(52) U.S. Cl. CPC G01M 5/0008; G08G 1/0116; G08G 1/0129; G08G 1/015; G08G 1/065; G06F 17/14

(57) ABSTRACT

Provided an apparatus including: a signal acquisition part that acquires an oscillation signal from a sensor that detects an oscillation induced in a target object; and an estimation part that obtains a feature value for each frame of the oscillation signal by applying Fourier transform to each frame extracted by a window of a predetermined length to calculate the feature value for the each frame in a frequency domain, and performs Gaussian mixture model-clustering on a time series of the feature values for respective frames to estimate one or more clusters, each of which is modeled with a Gaussian probability distribution best fit to the time series, and detect one or more events by detecting one or more corresponding clusters, a probability density value thereof greater than a predetermined threshold value.

This application is a National Stage Entry of PCT/JP2020/010720 filed on Mar. 12, 2020, the contents of all of which are incorporated herein by reference, in their entirety.

### FIELD

The present invention relates to an event detection apparatus, method and a non-transitory medium storing a program.

### BACKGROUND

Regarding detection using a response measured on a passing vehicle over a bridge, Non-Patent Literature (NPL) 1 discloses an automatic Vehicle Detection (AVD) algorithm that takes acceleration response data (time histories) of the bridge under traffic load and gives the automatic vehicle count. The AVD algorithm of NPL 1 gives information about traffic, such as total number of vehicles (vehicle count) that have passed during an interval of time. Headway is difference in time, or distance, between a leading vehicle and a following vehicle in a highway traffic situation. Time headway (T_{HW}) and distance headway (D_{HW}) are interrelated through vehicle speed (V) by T_{HW}=D_{HW}/V as illustrated in FIG. 9A and FIG. 9B which are cited from FIG. 1 and FIG. 2 of NPL1. AVD performs Vehicle Identification using a dictionary to identify a vehicle. AVD can distinguish between the two vehicles if the following condition holds: T_{HW}>=T_{HWmin}, where T_{HWmin} is minimum time headway. Minimum time headway (T_{HWmin}) is predefined in AVD and its value is set to a value with which most trucks are going to follow each other. Any pair of trucks traveling so that T_{HW}<T_{HWmin} will be considered as a single vehicle. That is, AVD cannot discriminate individual ones of a pair of trucks travelling with T_{HW}<T_{HWmin}.

Patent Literature (PTL) 1 discloses a travelling vehicle number measurement device using Doppler type detection sensor enabled to correctly count the number of vehicles traveling on one lane road.

PTL 2 discloses a system wherein multiple sensors are arranged spaced apart with a predetermined distance ML in a direction parallel to a lane in each lane of a bridge to detect an axle interval(s) of a vehicle passing through the bridge. In an axle passing time group, a point where the passing time difference between axles is larger than a preset value is defined as a vehicle-to-vehicle separation and an axle interval(s) for each vehicle is detected. An active load strain, a time at which the k-th axle in the lane P has passed a reference position, a speed of the k-th vehicle on the lane P, and the lane P in which the vehicle is passing is acquired. By collating the axle intervals of a vehicle passing the lane of the bridge with reference to a database in which relationship between an axle interval(s) and a vehicle type is stored in advance, the type of the vehicle passing through the bridge is automatically detected substantially in real time.
[PTL 1] Japanese Unexamined Patent Application Publication No.2011-204138
[PTL 2] Japanese Unexamined Patent Application Publication No.2006-084404
[NPL 1] Kanwardeep Singh Bhachu, J. David Baldwin, Kyran D. Mish, “Method for Vehicle Identification and Classification for Bridge Response Monitoring”, Proceedings of the IMAC-XXVIII Feb. 1-4, 2010, Jacksonville, Fla. USA
[NPL 2] 2.1. Gaussian mixture models, retrieved on Jan. 8, 2020, <Internet URL https://scikit-learn.org/stable/modules/mixture.html>
[NPL 3] David M. Blei, Michael I. Jordan, “Variational inference for Dirichlet process mixtures”, 2006 International Society for Bayesian Analysis, 1, Number 1, pp. 121-144, retrieved on Jan. 8, 2020, <Internet URL http://www.cs.columbia.edu/˜blei/papers/BleiJordan2004.pdf>

### SUMMARY

The following analysis is made by the inventors of the present invention.

The AVD algorithm disclosed in NPL1 can identify or discriminate an individual vehicle in a situation where there is a vehicle (truck) travelling on a lane with a time headway T_{HW} between the vehicle (truck) and other leading/following vehicle (truck) being more than or equal to the time headway minimum. However, the AVD algorithm cannot well identify/discriminate vehicles in the following traffic situation. As illustrated in FIG. 10A, on a single lane 1, a small vehicle 2 (2-axle car) follows a large vehicle 1 (5-axle truck). As shown in FIG. 10B, an oscillation signal (acceleration data) of the bridge induced by the small vehicle 2 is buried in the oscillation signal (acceleration data) of the bridge induced by the large vehicle 1. The AVD algorithm disclosed in NPL 1 fails to detect and identify the small vehicle 2 following the large vehicle 1 in a series model with vehicle types combined. The signal shown in FIG. 10B corresponds to the signal measured in the same location as defined in AVD algorithm, i.e., the acceleration signal of FIG. 10B is measured below the bridge as proposed in the AVD algorithm disclosed in the Non-Patent Literature (NPL) 1.

Accordingly, it is one of objects of the present invention to provide an event detection apparatus, a method, a non-transitory medium storing a program, each enabling to identify serial events in time series.

According to one aspect of the disclosure, there is provided an event detection apparatus comprising:

a signal acquisition part that acquires an oscillation signal from a sensor that detects an oscillation induced in a target object; and

an estimation part that obtains a feature value for each frame of the oscillation signal by applying Fourier transform to each frame extracted by a window of a predetermined length to calculate the feature value for the each frame in a frequency domain, and

performs Gaussian mixture model-clustering on a time series of the feature values for respective frames to estimate one or more clusters, each of which is modeled with a Gaussian probability distribution best fit to the time series, and detect one or more events by detecting one or more corresponding clusters, a probability density value thereof greater than a predetermined threshold value.

According to another aspect of the disclosure, there is provided a computer-based event detection method comprising:

acquiring an oscillation signal from a sensor that detects an oscillation induced in a target object;

obtaining a feature value for each frame of the oscillation signal by applying Fourier transform to each frame extracted by a window of a predetermined length to calculate the feature value for the each frame in a frequency domain;

performing Gaussian mixture model-clustering on a time series of the feature values for respective frames to estimate one or more clusters, each of which is modeled with a Gaussian probability distribution best fit to the time series; and

detecting one or more events by detecting one or more corresponding clusters, a probability density value thereof greater than a predetermined threshold value.

According to a third aspect of the disclosure, there is provided a program for causing a computer to execute processing comprising:

acquiring an oscillation signal from a sensor that detects an oscillation induced in a target object;

obtaining a feature value for each frame of the oscillation signal by applying Fourier transform to each frame extracted by a window of a predetermined length to calculate the feature value for the each frame in a frequency domain;

performing Gaussian mixture model-clustering on a time series of the feature values for respective frames to estimate one or more clusters, each of which is modeled with a Gaussian probability distribution best fit to the time series; and

detecting one or more events by detecting one or more corresponding clusters, a probability density value thereof greater than a predetermined threshold value.

According to the disclosure, there is provided a computer-readable recording medium in which the program according to the above described third aspect of the disclosure is stored. The recording medium may be such as a semiconductor storage (such as read only memory (ROM), random access memory (RAM), electrically and erasable programmable read only memory (EEPROM)), Hard Disk Drive (HDD), Solid State Drive (SSD), Compact Disc (CD) or Digital Versatile Disc (DVD) etc.

According to embodiments of the present invention, it is made possible to detect and identify serial events in the time-series, such as, detection and identification of vehicles serially passing over a bridge, mechanical oscillation, detection, and identification of serial emission of sound, and so forth.

### BRIEF DESCRIPTION OF DRAWINGS

FIGS. 1A and 1B are diagrams illustrating an embodiment of the invention.

FIG. 2 is a diagram illustrating an arrangement of an event detection system.

FIGS. 3A and 3B are diagrams illustrating an example of the embodiment.

FIG. 4 is a flowchart illustrating an operation example of the embodiment.

FIGS. 5A to 5C are diagrams illustrating an example of the embodiment.

FIGS. 6A and 6C are diagrams illustrating an example of the embodiment.

FIGS. 7A and 7B are diagrams illustrating an example of the embodiment.

FIG. 8 is a diagram illustrating an arrangement of a vehicle detection system of the embodiment.

FIGS. 9A and 9B are figures cited from NPL1.

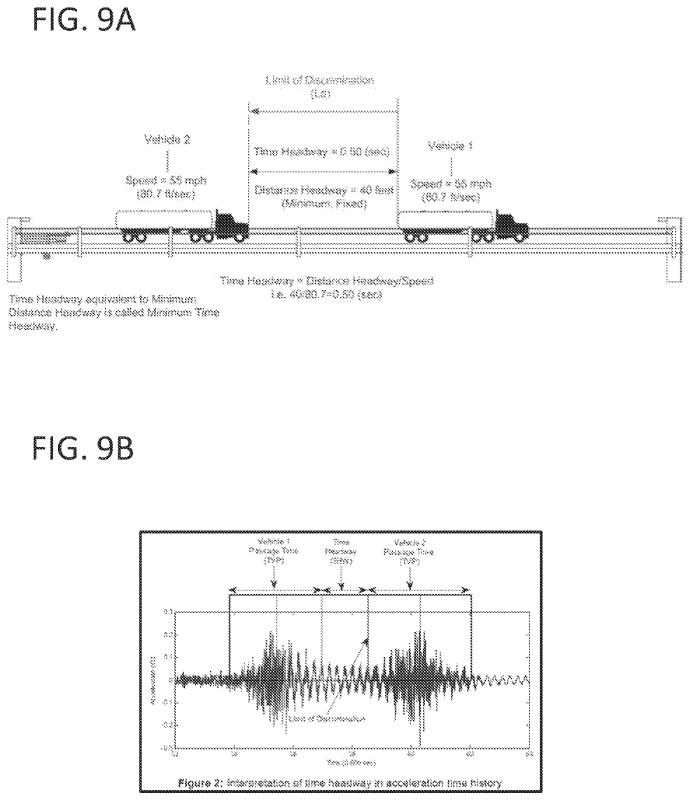

FIGS. 10A and 10B are a diagram and an example of an acceleration signal of serial model.

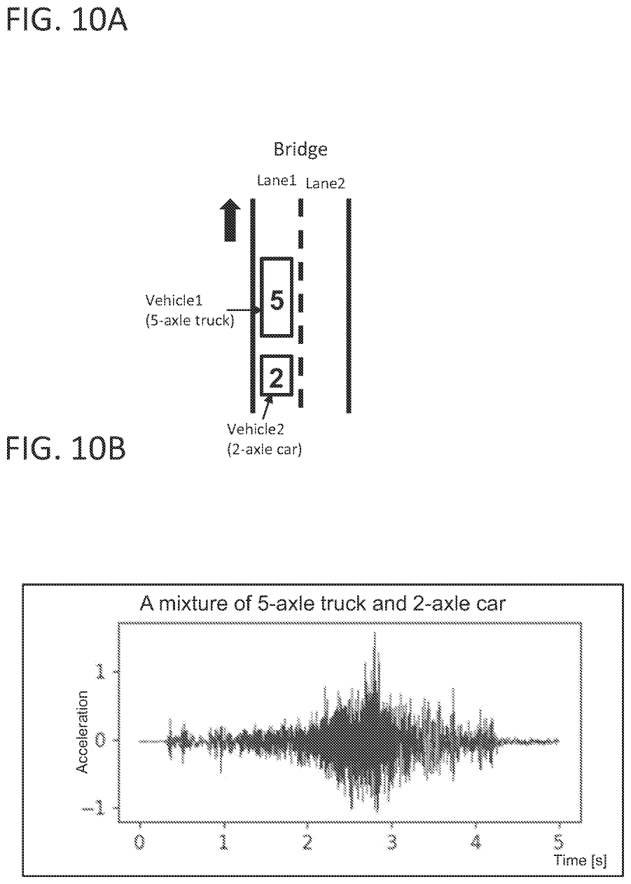

### DETAILED DESCRIPTION

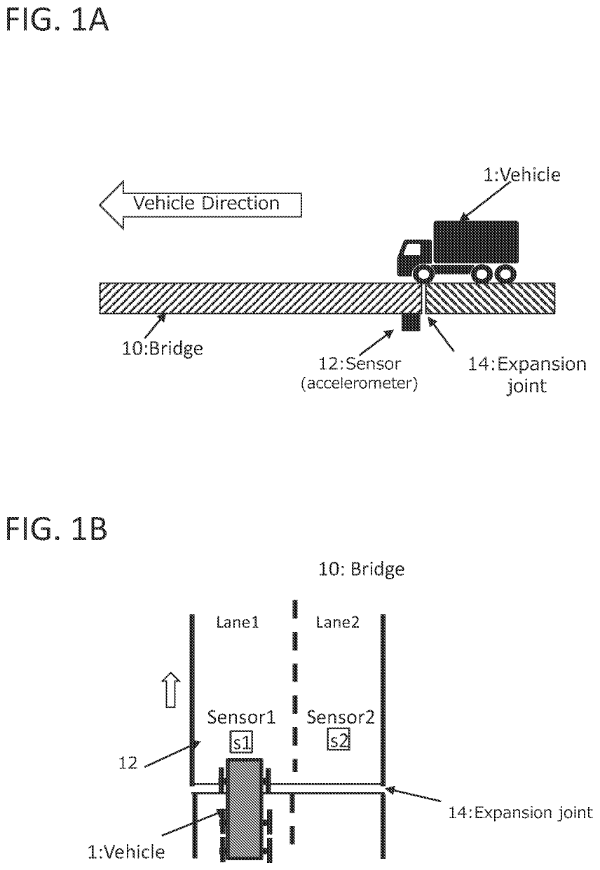

The following describes an example embodiment with reference to drawings. FIGS. 1A and 1B are a schematic diagram illustrating the example embodiment of the present invention, respectively. FIG. 1A is a schematic illustration of a side view, while FIG. 1B is a schematic illustration of a plan view. Referring to FIGS. 1A and 1B, an expansion joint 14 is a joint provided between separate structures with different properties to accommodating movement, shrinkage, and temperature variations on reinforced and pre-stressed concrete, composite, and steel structures. An accelerometer is used as a sensor 12 which is provided for each lane below a concrete slab of the bridge 10 close to an edge point of the bridge 10. A response oscillation (impulse response (damping pattern)) of the bridge 10 due to a vehicle passing over the bridge 10 is measured by the sensor 12 which may be placed at an entry point under the bridge 10. The oscillation signal (acceleration data) captured by the sensor 12 is transmitted in digital data via wired or wireless communication to an event detection apparatus not shown.

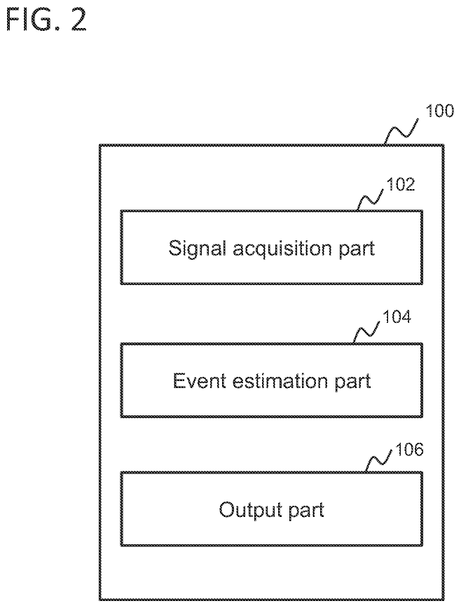

FIG. 2 is a schematic diagram illustrating an example of an arrangement of an event detection apparatus of the example embodiment. Though not limited thereto, the following describes the event detection apparatus 100 directed to vehicle detection, wherein an event to be detected is a presence of a vehicle passing over a bridge. Referring to FIG. 2, the event detection apparatus 100 includes a signal acquisition part 102, an event estimation part 104, and an output part 106. The signal acquisition part 102 acquires an oscillation signal (acceleration data) from the sensor (12 in FIGS. 1A and 1B) communicatively connected to the signal acquisition part 102. The sensor is able to detect an oscillation signal of an impulse response of the bridge induced by a mechanical impulse given to the bridge (lane) by each of axles of a vehicle, when the vehicle is passing on the lane of the bridge. The event estimation part 104 detects and identifies vehicles serially passing on the lane based on the oscillation signal (acceleration data) to count vehicles passing on the lane. The event estimation part 104 calculates time repeated vector of an amplitude (feature value) from the oscillation signal and performs clustering on the time repeated vector to detect presence of a vehicle(s) on the lane. The output part 106 outputs the detection result (e.g., the number of vehicles passing on the lane) to a display apparatus, in a storage apparatus, or via a communication network to a terminal or a computer system. The signal acquisition part 102, event estimation part 104, and output part 106 may be implemented by a processor that is included in the event detection apparatus 100 and execute program instructions stored in a memory included in the event detection apparatus 100.

The following describes an example of an operation of the event estimation part 104 which can detect and identify vehicles passing on a single lane, serially with combined vehicle types, e.g., a large vehicle (such as 3 or more axle truck) and a small vehicle (2-axle car).

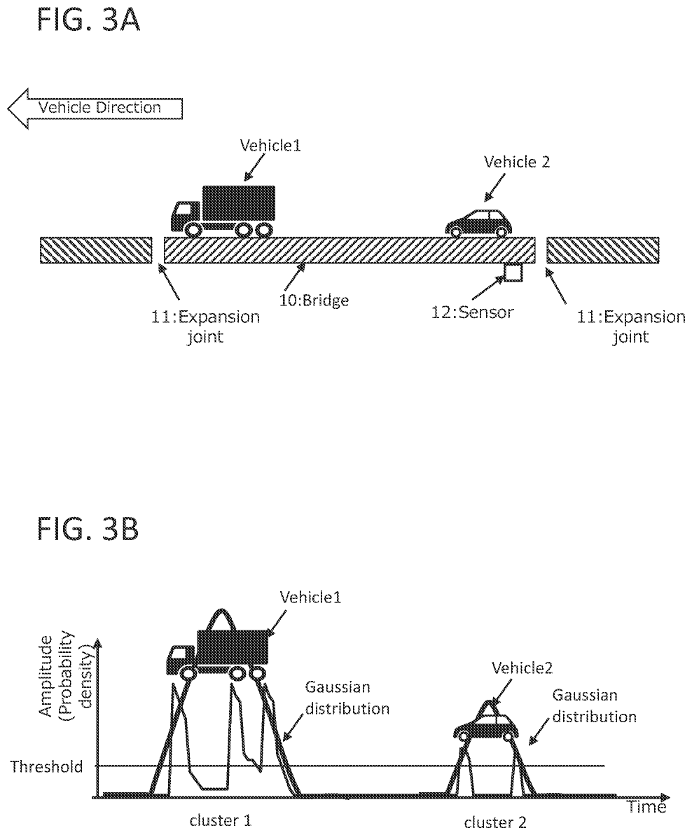

FIG. 3A illustrates an example of traffic situation where a vehicle 1 (3-axle truck) and a vehicle 2 (2-axle car) following the vehicle 1 are present on the lane 1 of the bridge 10. The vehicle 2 is preferably spaced apart from the leading vehicle 1 by a time interval of e.g., about 0.5 seconds or more, though not limited thereto. FIG. 3B illustrates estimation of the number of vehicles based on clustering using a Gaussian mixture model. The number of Gaussian probability density function(s) obtained by the clustering and taking a value greater than a predetermined threshold value is counted as the number of vehicles.

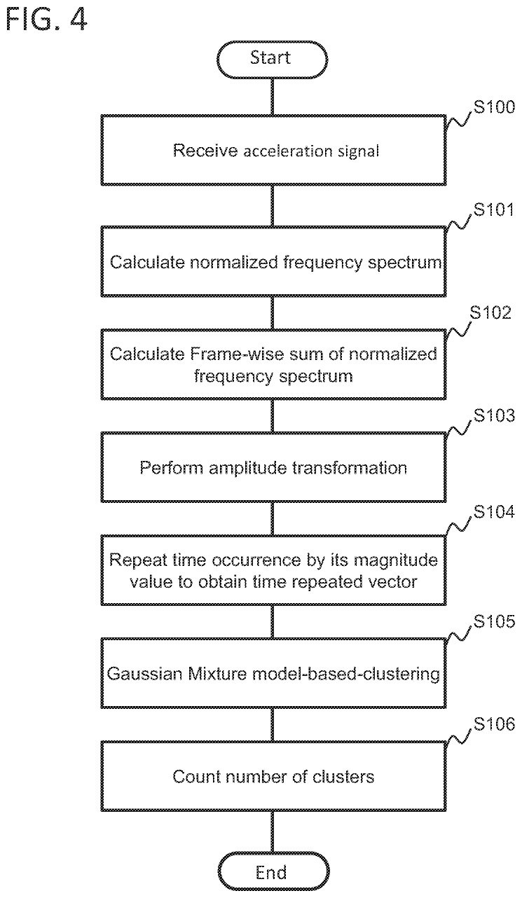

FIG. 4 is a flow chart illustrating an operation example of the event estimation part 104 which detects individual vehicles passing a lane.

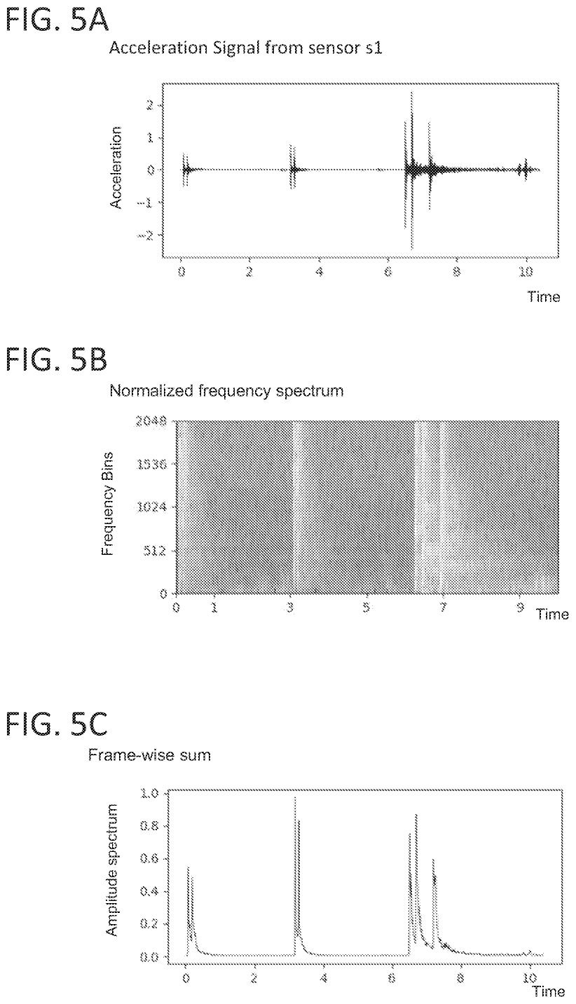

The event estimation part 104 receives, from the signal acquisition part 102, the oscillation signal (acceleration signal from the sensor s1), as shown in FIG. 5A (S100). The signal acquisition part 102 may cut off a DC component of the oscillation signal.

The event estimation part 104 is configured to detect a vehicle (s) passing serially on a single lane (e.g., lane 1) from the oscillation signal of lane 1 captured by the sensor sl.

The event estimation part 104 calculates a normalized frequency spectrum (S101). FIG. 5B shows a normalized frequency spectrum of the oscillation signal shown in FIG. 5A. More specifically, the event estimation part 104 applies short-time fast Fourier transform (STFT) to the oscillation signal shown in FIG. 5A. That is, using a sliding window of a predetermined length, each shifted by predetermined value, each frame is extracted from the oscillation signal. FFT is applied to each frame to obtain a frequency spectrum of each frame. Discrete Fourier transform (DFT) may as a matter of course be used in place of FFT.

Let's X=(x⁰, x¹ . . . , x^{N-1}, x^{N}, . . . ) be time series of sampled values x^{k} (k is non-negative integer) of the oscillation signal (oscillation signal) with a shift of the sliding window=m, frames Xⱼ (j=1, 2, 3 . . . ) with length N (N>m) are extracted by the sliding window from the oscillation signal and N-point FFT is applied to each frame to obtain a frequency spectrum Y(ω)ⱼ of the j-th frame Xⱼ (j=1, 2, 3 . . . ),

X₁=[x⁰, . . . , x^{N-1}]→Y(ω)₁=FFT(X₁)

X₂=[x^{m-1}, . . . , x^{N+m-2}]→Y(ω)₂=FFT(X₂)

X₃=[x^{2m-1}, . . . , x^{N+2m-3}]→Y(ω)₃=FFT(X₃)

The event estimation part 104 calculates a normalized frequency spectrum by dividing each frequency component (amplitude) by a total sum of amplitudes of the frequency component. The total sum Sⱼ of amplitude spectrum qⱼ for j-th frame Xⱼ is given by

$${S}_{j} = {\sum }_{i = 1}^{\frac{N}{2} - 1} {q}_{j} ( i ) \qquad ( 1 )$$

where qⱼ(i) is an amplitude of i-th frequency bin of the frequency spectrum Y(ω)₁ of the j-the frame Xⱼ.

qⱼ(i)={square root over (Re(yⱼ(i))²+Im(yⱼ(i))²)} (2)

where yⱼ(i) (i=1, . . . , N/2) is an i-th frequency component (complex number) of the frequency spectrum Y(ω)ⱼ and, Re( ) and Im( ) are real part and imaginary part of complex yⱼ(i) where yⱼ(0) (i=0) is a DC component, an imaginary part of which is zero and a real part of which is assumed to be zero, and an index i=N/2 corresponds to the Nyquist frequency bin.

The normalized frequency spectrum Qⱼ for the j-th frame Xⱼ is given as

$${Q}_{j} = ( \frac{1}{{S}_{j}} ) [ {q}_{j} ( 1 ) , … , {q}_{j} ( \frac{N}{2} - 1 ) ] \qquad ( 3 )$$

The event estimation part 104 calculates a frame-wise sum of a normalized frequency spectrum (S102).

The frame-wise sum f(j) of the normalized frequency spectrum for j-th frame Xⱼ (j=1, 2, . . . ) is given as

$$f ( j ) = {\sum }_{i = 1}^{\frac{N}{2} - 1} {q}_{j} ( i ) \qquad ( 4 )$$

FIG. 5C shows the frame-wise sum for each frame. In FIG. 5C, values of the frame-wise sum f(j) (j=1, 2, 3, . . . ) are plotted, where a horizontal axis is a time axis (i.e., index j=1, 2, 3, . . . ) and a vertical axis is the value of the frame-wise sum: f(j). FIG. 5C is a plot of the following vector (frame-wise sum vector),

F=(f(1), f(2), f(3), . . . ) (5)

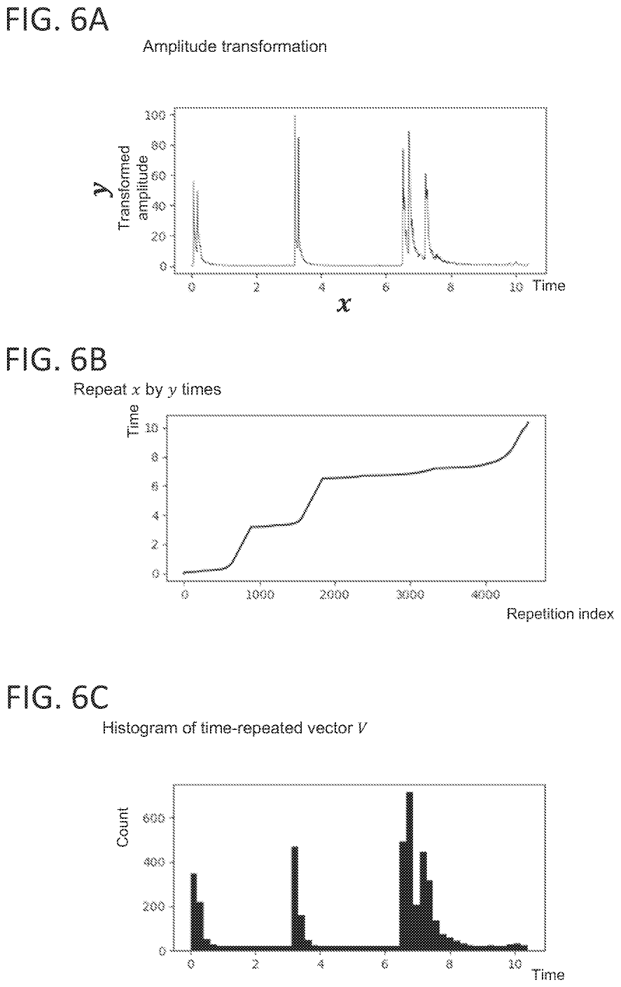

The event estimation part 104 performs amplitude transformation of the vector F to scale in pre-defined range (S103). FIG. 6A shows a result of amplitude transformation of the frame-wise sum vector shown in FIG. 5C. In the example of FIG. 6A, the vector F in FIG. 5C is transformed to a vector F_scaled of a range between 0 and 100, though not limited thereto.
scaled_min=0,
scaled_max=100,
F_min=min(F),
F_max=max(F).

The amplitude transformation is calculated as:

F_scaled=scale*F+scaled_min−F_min*scale (6)

where

scale=(scaled _max−scaled_min)/(F_max−F_mim) (7)

The event estimation part 104 creates a new vector (time-repeated vector) from the vector F_scaled by repeating time value by its magnitude value (S104). FIG. 6B shows an example of the new vector (time-repeated vector), where a vertical axis is a time axis and a horizontal axis is a repetition index. More specifically, the event estimation part 104 repeat time occurrence by its magnitude. The event estimation part 104 repeats x (time value) by y (scaled amplitude) times, i.e., (time value)*(scaled amplitude at the corresponding time). For example, in FIG. 6A, at time: 0 (index 0 of F_scaled), scaled amplitude (value of an element 0 of F_scaled) is 2, so time-repeated vector V starts with a time value 0 repeating 2 times, next, at time: 1 (index 1 of F_scaled), scaled_amplitude (value of an element 1 of F_scaled) is 10, so repeating a time value 1 by 10 times. After the multiplication for all time value is iterated, we have a new time-repeated vector V, as shown in FIG. 6B. In FIG. 6B, a time axis (horizontal axis) is an index of each element of the time-repeated vector V and a vertical axis is a value of each element of the time-repeated vector V.

Assuming that each vehicle is estimated based on a Gaussian Mixture model, transforming the signal to time-repeated feature makes it easy to perform clustering and vehicle detection by Gaussian Mixture Modelling. Fitting of Gaussian Mixture to the normalized frequency is performed to estimate occurrence time of a vehicle. A vehicle occurrence time in the oscillation signal is not known. To detect the vehicle occurrence time, repeating time value by a scaled amplitude times is adopted, which generates more density at a peak location of the amplitude. This operation results in an expected distribution (such as Gaussian probability distribution) at each vehicle occurrence, as shown in FIG. 6C, which is a histogram (time-axis histogram) of the time-repeated vector created by the event estimation part 104.

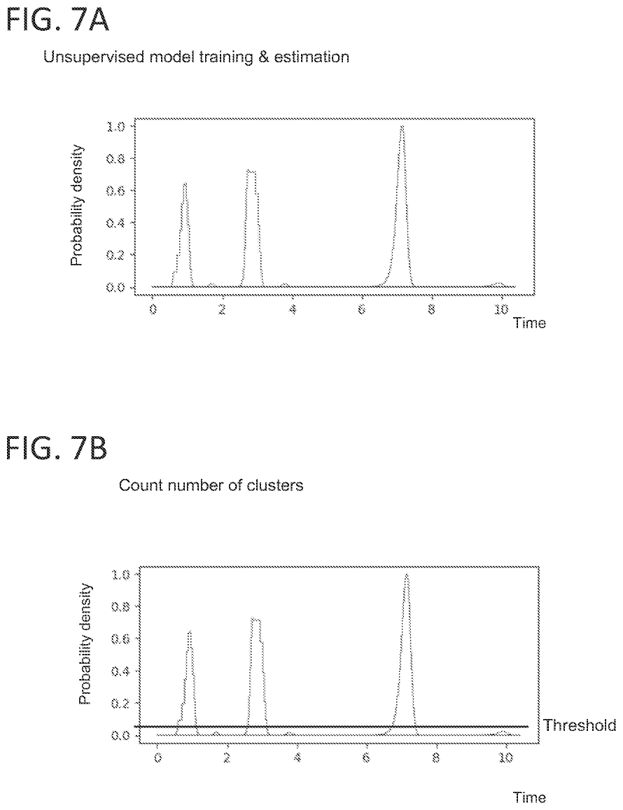

The event estimation part 104 performs clustering based on learning (unsupervised model training) of a mixture of Gaussian probability distributions (S105). The Gaussian mixture model is a probabilistic model that assumes all the data points are generated from a mixture of a finite number of Gaussian probability distributions with unknown parameters. The Gaussian Mixture Model may be learned from train data. Though not limited thereto, in the embodiment, Variational Bayesian Gaussian Mixture model, a variant of the Gaussian mixture model with variational inference algorithms, such as Variational Bayesian DPGMM (Dirichlet Process Gaussian Mixture Model) is used, which is an infinite mixture model with the Dirichlet Process, as a prior distribution on the number of clusters. Regarding Variational Bayesian DPGMM, reference may be made to NPL2 or NPL3. FIG. 7A shows a clustering result of the time repeated vector V using Variational Bayesian DPGMM. In FIG. 7A, a horizontal axis is a time axis and a vertical axis is a scaled version of probability density value.

The event estimation part 104 counts the number of clusters, each of which has a value of a probability density function greater than a predetermined threshold value (S106), as shown FIG. 7B. The predetermined threshold value is defined to identify a response oscillation of the bridge induced by a vehicle passing on the lane of the bridge.

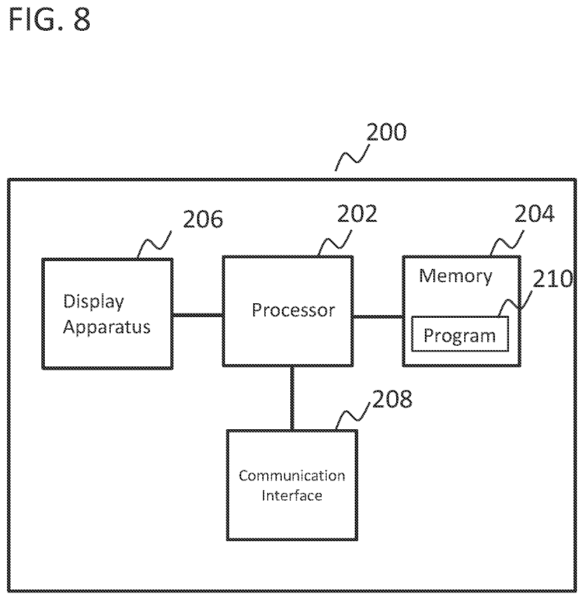

The event detection apparatus 100 may be implemented on a computer system as illustrated in FIG. 8. Referring to FIG. 8, a computer apparatus 200, such as a server, includes a processor (Central Processing Unit) 202, a memory 204 including, for example, a semiconductor memory (for example, Random Access Memory (RAM), Read Only Memory (ROM), Electrically Erasable and Programmable ROM (EEPROM)), and/or a storage device including at least one of Hard Disk Drive (HDD), SSD (Solid State Drive), Compact Disc (CD), Digital Versatile Disc (DVD) and so forth, a display apparatus 206 that display the result of detection of the number of a vehicle(s) passing on each lane, and a communication interface 208. The communication interface 208 (such as a network interface controller (NIC)) may well be configured to communicatively connect to sensor(s) provided under lanes of a bridge. A program 210 including program instructions (program modules) for executing processing of the signal acquisition part 102, the event estimation part 104 and the output part 106 of the event detection apparatus 100 shown in FIG. 2 is(are) stored in a memory 204. The processor 202 is configured to read the program 210 (program instructions) from the memory 204 to execute the program 210 (program instructions) to realize the function and processing of the event detection apparatus 100.

In the above embodiments, detection of the number of vehicles passing on a single lane of a bridge is described, but the present invention is not limited to the number of vehicles. The present invention can be applied to detection of weight of a vehicle passing on a single lane of a bridge, a load weight of a vehicle, a deterioration/fatigue diagnostic of a bridge, etc.

In the above embodiments, accelerometers are used as sensors to detect an impulse response (oscillation) of the bridge. However, in the present invention, a sensor is not limited to detection of an impulse response (oscillation) of the bridge. That is, the present invention is applicable to an oscillation signal detected by an acoustic sensor such as a piezoelectric transducer, microphone, etc., wherein sounds serially emitted may be detected and identified based on the signal output from the sensor.

Each disclosure of the above-listed PTLs 1-2 and NPLs 1-2 is incorporated herein by reference. Modification and adjustment of each example embodiment and each example are possible within the scope of the overall disclosure (including the claims) of the present invention and based on the basic technical concept of the present invention. Various combinations and selections of various disclosed elements (including each element in each Supplementary Note, each element in each example, each element in each drawing, and the like) are possible within the scope of the claims of the present invention. That is, the present invention naturally includes various variations and modifications that could be made by those skilled in the art according to the overall disclosure including the claims and the technical concept.

What is claimed is:

1. An event detection apparatus comprising:
at least a processor; and
a memory storing program instructions executable by the processor, wherein the processor is configured to execute the program instructions to implement:
a signal acquisition part that acquires an oscillation signal from a sensor that detects an oscillation induced in a target object; and
an estimation part that obtains a feature value for each frame of the oscillation signal by applying Fourier transform to the each frame extracted by a window of a predetermined length to calculate the feature value for the each frame in a frequency domain, and
performs Gaussian mixture model-clustering on a time series of the feature values for respective frames to estimate one or more clusters, each of which is modeled with a Gaussian probability distribution best fit to the time series, and detect one or more events by detecting one or more corresponding clusters, a probability density value thereof greater than a predetermined threshold value.

2. The event detection apparatus according to claim 1, wherein the estimation part calculates a normalized frequency spectrum of the each frame by normalizing a frequency spectrum of the each frame obtained by the Fourier transform,
calculates a frame-wise sum of an amplitude spectrum of the normalized frequency spectrum, for the each frame,
performs scaling of the frame-wise sum to a pre-defined range, obtains a time repeated vector of the scaled frame-wise sum by multiplying a time value of each scaled frame-wise sum by a magnitude of the each frame-wise sum, and
performs the Gaussian mixture model-clustering on the time repeated vector to detect and count the clusters, with the probability density value thereof greater than the predetermined threshold value.

3. The event detection apparatus according to claim 1, wherein the target object is a bridge including at least a lane, wherein
the signal acquisition part acquires the oscillation signal from the sensor capable of sensing an oscillation of the bridge induced by an individual axle of one or more vehicles passing on the lane, and wherein
the estimation part estimates a response oscillation of the bridge due to a vehicle passing on the lane by using the Gaussian mixture model-clustering to detect and count, as the one or more events, one or more individual vehicles passing on the lane by detecting and counting the clusters with the probability density value thereof greater than the predetermined threshold value.

4. A computer-based event detection method comprising:
acquiring an oscillation signal from a sensor that detects an oscillation induced in a target object;
obtaining a feature value for each frame of the oscillation signal by applying Fourier transform to the each frame extracted by a window of a predetermined length to calculate the feature value for the each frame in a frequency domain;
performing Gaussian mixture model-clustering on a time series of the feature values for respective frames to estimate one or more clusters, each of which is modeled with a Gaussian probability distribution best fit to the time series; and
detecting one or more events by detecting one or more corresponding clusters, a probability density value thereof greater than a predetermined threshold value.

5. The computer-based event detection method according to claim 4, further comprising:
in obtaining the feature value for each frame,
calculating a normalized frequency spectrum of the each frame by normalizing a frequency spectrum of the each frame obtained by the Fourier transform;
calculating a frame-wise sum of an amplitude spectrum of the normalized frequency spectrum, for the each frame;
performing scaling of the frame-wise sum to a pre-defined range; and
obtaining a time repeated vector of the scaled frame-wise sum by multiplying a time value of each frame-wise sum by a magnitude of the each frame-wise sum, the method comprising
performing Gaussian mixture model-clustering on the time repeated vector to detect and count clusters with the probability density value thereof greater than a predetermined threshold value.

6. The computer-based event detection method according to claim 4, wherein the target object is a bridge including at least a lane, the method comprising:
acquiring the oscillation signal from the sensor capable of sensing an oscillation of the bridge induced by an individual axle of one or more vehicles passing on the lane; and
estimating a response oscillation of the bridge due to a vehicle passing on the lane by using the Gaussian mixture model-clustering to detect and count, as the one or more events, one or more individual vehicles passing on the lane by detecting and counting the clusters with the probability density value thereof greater than the predetermined threshold value.

7. A non-transitory computer readable medium storing thereon a program causing a computer to execute processing comprising:
acquiring an oscillation signal from a sensor that detects an oscillation induced in a target object;
obtaining a feature value for each frame of the oscillation signal by applying Fourier transform to the each frame extracted by a window of a predetermined length to calculate the feature value for the each frame in a frequency domain;
performing Gaussian mixture model-clustering on a time series of the feature values for respective frames to estimate one or more clusters, each of which is modeled with a Gaussian probability distribution best fit to the time series; and
detecting one or more events by detecting one or more corresponding clusters, a probability density value thereof greater than a predetermined threshold value.

8. The program non-transitory computer readable medium according to claim 7, storing thereon the program causing the computer to execute processing further comprising:
in obtaining the feature value for each frame,
calculating a normalized frequency spectrum of the each frame by normalizing a frequency spectrum of the each frame obtained by the Fourier transform;
calculating a frame-wise sum of an amplitude spectrum of the normalized frequency spectrum, for the each frame; and
obtaining a time repeated vector of the frame-wise sum by multiplying a time value of each frame-wise sum by a magnitude of the each frame-wise sum,
wherein the processing comprises
performing Gaussian mixture model-clustering on the time repeated vector to detect and count clusters with the probability density value thereof greater than a predetermined threshold value.

9. The non-transitory computer readable medium according to claim 7, wherein the target object is a bridge including at least a lane, the medium storing the program causing the compute to execute processing comprising:
acquiring the oscillation signal from the sensor capable of sensing an oscillation of the bridge induced by an individual axle of one or more vehicles passing on the lane; and
estimating a response oscillation of the bridge due to a vehicle passing on the lane by using the Gaussian mixture model-clustering to detect and count, as the one or more events, one or more individual vehicles passing on the lane by detecting and counting the clusters with the probability density value thereof greater than the predetermined threshold value.
